(19) United States
(12) Patent Application Publication
(10) Pub. No.: US 2005/0036879 A1
(43) Pub. Date: Feb. 17, 2005

(54) Handling large, heavy workpieces using coordinated gantry robots

(76) Inventors: Nishant Jhaveri, Pontiac, MI (US); Ranganath Misra, Grand Blanc, MI (US); Ian H. Orr, Orion Township, MI (US); Richard M. Motley, Orion Township, MI (US)

Correspondence Address: MACMILLAN SOBANSKI & TODD, LLC;ONE MARITIME PLAZA FOURTH FLOOR, 720 WATER STREET, TOLEDO, OH, 43604-1619, US

(21) Appl. No.: 10/892,722

(22) Filed: Jul. 16, 2004

Related U.S. Application Data
(60) Provisional application No. 60/488,668, filed on Jul. 18, 2003.

(51) Int. Cl. B65G 1/133

(52) U.S. Cl. 414/751.1

(57) ABSTRACT

A robot system for handling and transporting workpieces in a workspace includes a rail supported above a floor, at least two robot arms supported on the rail for mutual relative displacement and coordinated displacement along the rail, each arm articulating about multiple axes for engaging and supporting the workpiece, and a controller communicating with each of the robot arms to control displacement and articulation of each robot arm, whereby the workpiece is engaged by each gripper, lifted on the robot arm, carried along a path, which may include motion along the rail, and released from the gripper at its destination.

### CROSS-REFERENCE TO RELATED APPLICATION

This application claims the benefit of U.S. Provisional Application No. 60/488,668, filed Jul. 18, 2003, the entire disclosure of which is incorporated herein by reference.

### BACKGROUND OF THE INVENTION

The subject invention generally relates to material handling of workpieces with a coordinated gantry. More specifically, the invention pertains to a system including a plurality of robots moveable along a rail. A single rail may support multiple robots, or each robot may be mounted on a separate rail.

Custom transfer automation equipment, heavy-duty area gantries and heavy-payload pedestal robots employ well known, conventional techniques for transporting large, heavy workpieces over short distances, as required on a plant floor.

Individual heavy-payload robots typically require very large tooling to engage large workpieces, severely eroding available payload capacity for the workpiece, and the gripper design is highly engineering intensive. The size and weight of the workpiece are constrained by the inertia capacities of the robot wrist axis. Such robots have limited reach if they are fixed to the floor, and they cannot achieve large transfer distances when handling large workpieces. To achieve large transfer distances individual heavy-payload robots present sizable physical obstacles at floor level if mounted to a floor, rail, or track. They cannot adapt easily to a variety of workpiece sizes, and may require additional tooling or changeover adjustment to reposition tooling structure and components.

Custom transfer automation equipment is custom-engineered for each application, requiring intensive engineering effort, and lengthy lead-time. This equipment is inflexible, or requires high complexity to achieve the needed flexibility. It is space-intensive and installation-intensive, requiring long commissioning times, especially if it is sizable enough to accommodate extremely heavy workpieces.

Conventional gantries do not easily support workpiece orientation change and control in conjunction with workpiece transfer. They typically require large tooling to engage large workpieces, and the tooling design is engineering-intensive, especially if workpiece orientation change is required and integrated into the tooling. Conventional gantries require high ceiling clearance if a fixed mast is used, or high capital cost and reduced load capacity if a telescoping mast is used. Their footprint is much larger than the usable motion range due to the extensive gantry structure. They require large space and installation resources, especially if their size accommodates extremely heavy workpieces.

### SUMMARY OF THE INVENTION

The present invention provides a coordinated, six-axis gantry robot having high load capacity with orientation control to manipulate large, heavy workpieces. An elevated rail axis or axes provide a large range of motion for a wide range of workpiece sizes, thereby conserving plant floor space without interfering with material flow at the floor level.

The invention provides a system for moving workpieces with a plurality of robots moveable along the rail or rails independently and in mutual coordination. The robots are controlled in accordance with control algorithms in the form of computer programs stored in memory accessible to a controller. Under control of the controller the robot arms grip, raise, carry, lower, and release various workpieces along paths, which can include motion along one rail or multiple rails using several robots whose movements are coordinated.

A robot system for handling and transporting workpieces in a workspace includes a rail or rails supported above a floor, at least two robot arms supported on the rail or rails for independent displacement and coordinated displacement, each arm articulating independently or in coordination about multiple axes to engage and support the workpiece. A controller communicates with each of the robot arms to control displacement and articulation of the robot arms. Each robot gripper at a first location engages the workpiece, lifts it, manipulates it while traversing a desired path, which may include motion along one or more rails, and releases it from the gripper at its destination.

Compared to individual heavy-payload pedestal robots, the tooling design of a coordinated articulated gantry robot is greatly simplified, and each robot's tooling can be made both smaller and lighter, thereby maximizing the payload capacity available for the workpiece. The size of the workpieces is not limited by the inertia capacity of the robot wrist axis or axes, mobility afforded by the robots' rail axis or axes allows large transfer distances for large workpieces, and the elevated rail installation improves material logistics and process flow at floor level. The coordinated robots are combined to achieve a high degree of automatic changeover flexibility. They can adjust for various part sizes and shapes, using the rail axis or axes to achieve significant adjustment range, and they can engage different workpieces at the optimal location and orientation, using independent tooling attached to independent, six-degree-of-freedom robots.

Compared to custom transfer automation, a standard robotic product can be applied to coordinated articulated gantry robots with minimal custom engineering and standard lead times. A highly flexible solution combines standard six-degree-of-freedom robots and allows simple tooling. Elevated installation preserves plant floorspace. Installation and commissioning are manageable because high capacity is achieved by combining the capabilities of multiple lighter-duty pieces of equipment.

Compared to conventional gantries, control of the workpiece orientation and part transfer are achieved easily with the standard configuration of coordinated articulated gantry robot. Tooling design and hardware are simplified and of lighter duty, and they do not incorporate devices for workpiece orientation change and control. High ceiling clearance is not required, and the system footprint is contained entirely within the operating range of the robots, thereby conserving plant floorspace.

### DESCRIPTION OF THE DRAWING

The advantages of the present invention will become readily apparent to those skilled in the art from the following detailed description of a preferred embodiment when considered in the light of the accompanying drawings in which:

FIG. 1 is a top plan view of a rail supported by columns above a plant floor, the rail supporting two articulating robot arms from a horizontal surface of the rail in an “underslung” configuration, according to the present invention;

FIG. 2 is a side elevation view of the arrangement of FIG. 1;

FIG. 3 is a side view of a rail supported by columns above a plant floor, the rail supporting an articulating robot arm from a vertical surface in a “sideslung” configuration, according to an alternate embodiment of the present invention;

FIG. 4 is a side view of the arrangement of FIGS. 1 and 2;

FIG. 5 is an isometric view of a representative robot arm similar to that shown in FIGS. 1 through 3;

FIG. 6 is a side elevation view of the two robot arms shown in FIGS. 1 and 2 engaged with a workpiece; and

FIG. 7 is an end elevation view of an alternate embodiment dual arm robot engaged with a long workpiece.

### DESCRIPTION OF THE PREFERRED EMBODIMENT

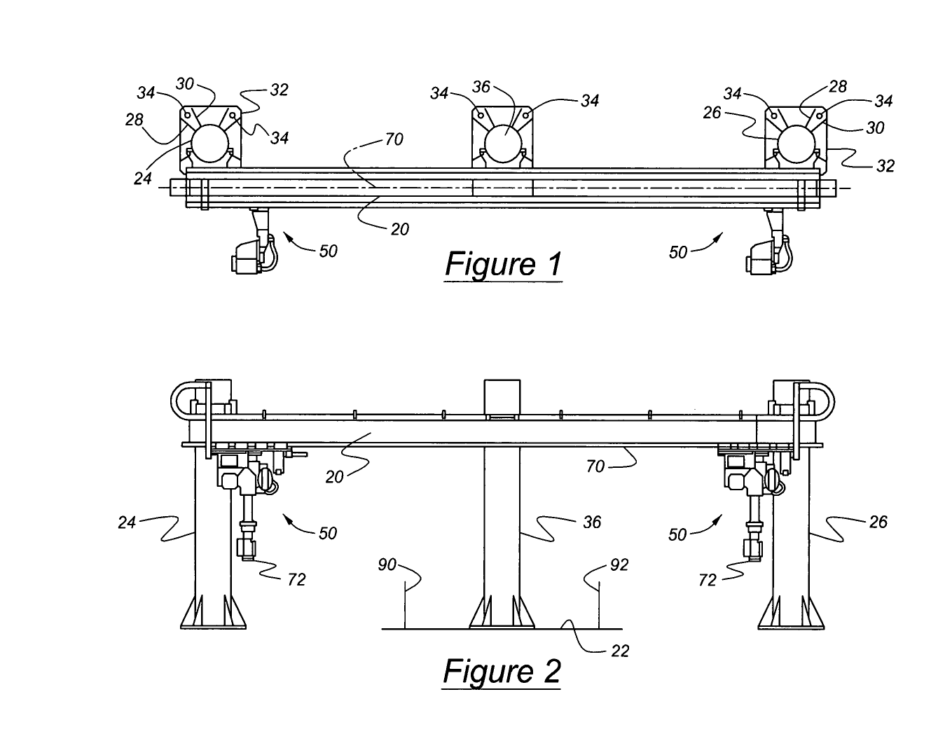

FIGS. 1-4 illustrate a rail 20 suspended above a workspace on the floor 22 of an industrial plant. The rail 20 is supported near each end by a column 24, 26, which is preferably in the form of a circular, cylindrical hollow tube. Located at the base of each column and extending radially from the column are pairs of flanges 28, 30, which are welded to the column and to a base plate 32. Bolts 34, located around the perimeter of the base plate 32, secure the base plate 32 to the floor 22 or to a footing located at or near the plane of the floor. When the span between the columns 24, 26 exceeds a predetermined length, at least one additional column 36, located between the end columns 24, 26, can be used to provide intermediate support to the rail 20.

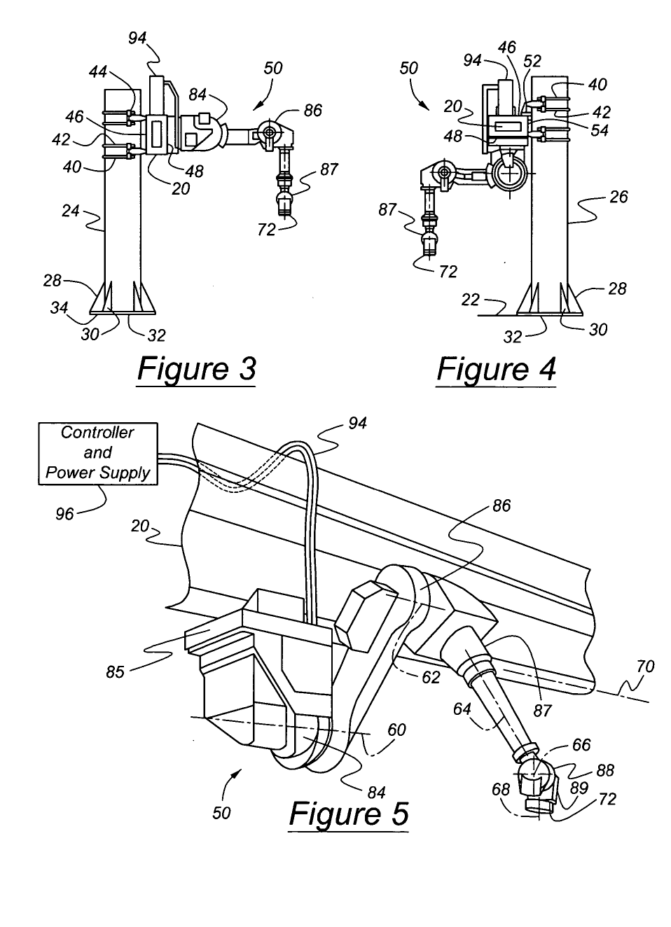

FIGS. 3 and 4 show the rail 20 secured to and spaced a short distance from the columns 24, 26 by pairs of U-bolts 40, 42, which engage the circular cylindrical contour of the columns and are secured by fasteners 44 threaded onto the bolts 40, 42. The rail 20 includes a first lateral surface 46 on one side and an opposite parallel second lateral surface 48 on which a robot arm 50 is mounted. In FIG. 4, the rail 20 is oriented with the lateral surface 46 in a horizontal plane facing upwardly and the lateral surface 48 facing downwardly. The rail 20 secured to the columns 24, 26 by the U-bolts 40, 42 at a bracket 52 mounted on the surface 46 and the U-bolts 40, 42 at a shorter third lateral surface 54 of the rail extending in a vertical plane and facing the columns. The robot arm 50 is secured at the surface 48 for displacement along the rail 20 in an “underslung” configuration corresponding to FIGS. 1 and 2.

In FIG. 3, the rail 20 is rotated ninety degrees from FIG. 4 and is oriented with the lateral surface 46 in a vertical plane facing the columns 26, 28 and the lateral surface 48 facing away from the columns. The robot arm 50 is secured at the surface 48 for displacement along the rail 20 in a “sideslung” configuration.

The robot arms 50 are electric servo-driven robot arms, which move along rail 20 for material handling and machine tending purposes. The “sideslung” position (FIG. 3) maximizes the vertical extraction stroke of the robot arm; the “underslung” position (FIG. 4) maximizes the symmetrical work envelope. The rail can be disposed in relation to the vertical plane between 0 degrees (underslung) and 90 degrees (sideslung) to optimize articulation of the robot arm 50. The distances along which robots 50 can travel on the rail 20 vary. Preferably, brushless AC servomotors (not shown) are used to move the robot arms 50 along the rail 20 with a rack and pinion rail drive (not shown).

Preferably, more than one robot arm 50 is supported on each rail 20, as shown in FIGS. 1 and 2. Alternatively, multiple rails may be constructed in close mutual proximity, each rail supporting one of the robot arms 50, or multiple robot arms. In either case, the robot arms 50 are controlled to cooperate in gripping a large workpiece and transporting the workpiece between a pickup location and a release location. The robot arms 50 may reach on both sides of the rail 20 to allow increased workspace, or each robot arm may handle an individual workpiece within the capacity and reach of a single robot arm, without cooperation with another robot arm.

Preferably, each robot arm 50 has six degrees of freedom by articulating about multiple axes 60, 62, 64, 66, 68, and being linearly displaceable along an axis 70 of the rail 20, as FIG. 5 shows. Located at a free end of the arm 50 is a wrist 72, to which a gripper may be secured for movement with the wrist. The gripper may employ any of the techniques that are commonly used by robot arms to engage, lift, carry and release a workpiece including, without limitation, magnetic, hydraulic, pneumatic, vacuum and mechanical techniques.

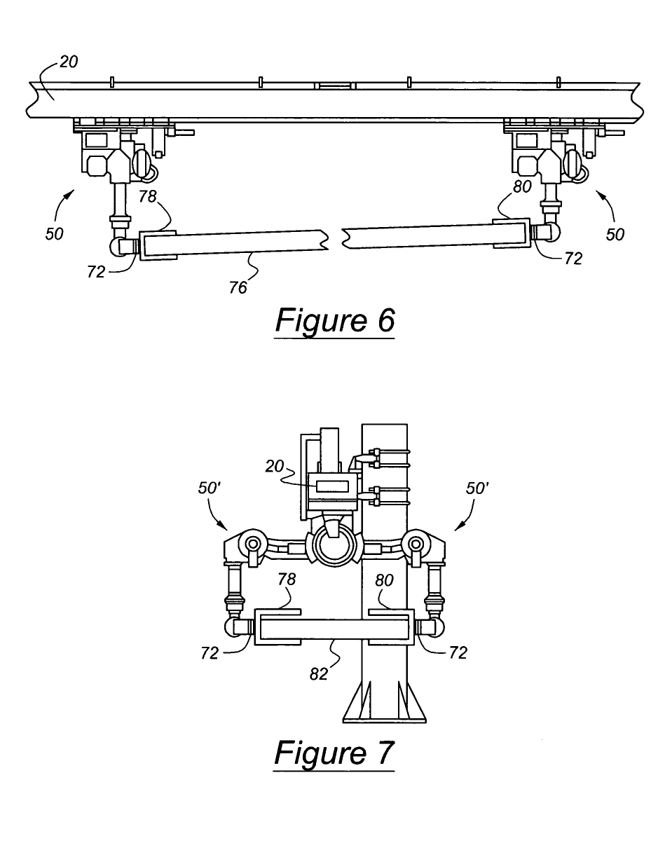

FIG. 6 shows a workpiece 76 engaged by grippers 78, 80, each gripper being supported by a wrist 72 on one of the robot arms 50 that cooperate to transport the workpiece. Preferably, both robot arms 50 are supported on a single one of the rails 20. When the workpiece 76 has a uniform weight distribution, such as an I-beam or an extruded component, and the grippers 78, 80 engage the workpiece 76 at opposite ends, each robot arm 50 supports approximately one-half of the workpiece's weight without inducing appreciable moment to the wrist 72.

When the robot arms 50 are supported on the same rail and the workpiece 76 is relatively long, the arms 50 may extend in the same lateral direction from the rail, and the workpiece may be carried along the rail either with the workpiece parallel, perpendicular, or oblique to the rail axis 70. However, when a workpiece 82 is relatively short, a dual arm robot has arms 50′ that preferably extend in opposite lateral directions from the rail 20, the workpiece is arranged perpendicular to the rail, and is carried along the rail from a pick-up location to a release location, as FIG. 7 illustrates. For example, as shown in FIG. 2, the grippers pickup the workpiece 76, 82 at any desired pickup location 90 and carry the workpiece along a path, which may include motion along the rail 20, to any other desired release location 92 where it is released by the grippers.

The robot arms 50, 50′ include actuating motors, located at the positions 84, 86, 87, 88, 89, each motor driving a robot arm axis 60, 62, 64, 66, 68 and causing the robot arm to articulate about a respective axis. Another motor 85 displaces the arm along the axis 70 of rail 20. The motors, which displace and articulate the robot arms 50, 50′ are connected by a conduit 94, which is connected to an electric power supply and microprocessor-based controller 96 (FIG. 5). The controller 96 is accessible to an electronic memory that contains algorithms, which coordinate movement of the robot arms and control the arms in lifting, holding, carrying and releasing the workpiece cooperatively. The control algorithms enable the system to reconfigure itself to handle workpieces of any length that can be accommodated within its travel space, which is determined by the length of the rail or rails 20. In addition to lifting and carrying the workpiece 76, 82, the robot arms 50, 50′ can articulate cooperatively to change the disposition of the workpiece relative to the rail or rails 20. This enables the workpiece 76, 82 to be moved from the pickup location 90 to the release location 92 and placed there at a different attitudinal disposition than that of the workpiece in the pickup location.

For example, FIG. 6 shows the robot arms 50 grasping opposite ends of the workpiece 76, the robot wrists 72 having articulated from the position shown in FIG. 2 so that the workpiece remains securely held by the grippers 78, 80. Thus, the robot wrists 72 have oriented the grippers 78, 80 along the longitudinal axis 70 of the rail 20 which is useful for carrying the workpiece 76 with a longitudinal axis parallel to the longitudinal axis of the rail. In FIG. 7, the robot wrists 72 have oriented the grippers 78, 80 transverse to the axis of the rail 20 for carrying the workpiece 82 transverse to the longitudinal axis 70.

The grippers 72 handle complex parts of varying geometry, size, and weight without the limitations on weight and size of conventional grippers. Multiple gripping locations allow individual grippers to be optimized for the specific gripping locations. This improves the weight lifting efficiency of the robots of the system according to this invention.

The practical limits are very high regarding size, weight, complexity, and number of gripping locations where the workpiece is engaged by the grippers. The robot arms 50, 50′ cooperate in handling and transporting a common workpiece, accommodating heavy, long workpieces having weight and length properties beyond the capability of an individual robot arm.

In accordance with the provisions of the patent statutes, the present invention has been described in what is considered to represent its preferred embodiment. However, it should be noted that the invention can be practiced otherwise than as specifically illustrated and described without departing from its spirit or scope.

1. A gantry robot system for handling and transporting workpieces of variable size, weight and dimensions in a workspace having a floor, comprising:
a rail supported above the floor;
at least two robot arms supported on the rail for mutual relative displacement and coordinated displacement along the rail, each arm supporting a gripper and capable of articulating about multiple axes for engaging and supporting the workpiece by the grippers; and
a controller communicating with each of the robot arms to control displacement and articulation of each robot arm, whereby the workpiece is lifted by the robot arms employing the grippers, carried, and released from the grippers.

2. The system of claim 1, further comprising:
first and second columns spaced mutually along the rail, extending upward from the floor, and secured at a base; and
wherein the rail is located adjacent the columns, and includes a first surface secured to the columns, and a second vertically disposed surface on which the robot arms are supported.

3. The system of claim 1, further comprising:
first and second columns spaced mutually along the rail, extending upward from the floor, and secured at a base; and
wherein the rail is located adjacent the columns, and includes a first surface secured to the columns, and a second surface on which the robot arms are supported.

4. The system of claim 1, wherein each robot arm includes:
multiple axes disposed along the arm and about which the arm articulates; and
a wrist located at an end of the arm for supporting a gripper thereon.

5. The system of claim 1, wherein each gripper is secured to the respective robot arm for movement therewith, each gripper engaging the workpiece such that movement of the workpiece relative to the gripper is prevented while the gripper is engaged with the workpiece.

6. The system of claim 1, wherein each gripper engages and supports a workpiece due to at least one of electromagnetic, hydraulic, pneumatic, vacuum, and mechanical actuation.

7. A method for moving a workpiece, comprising the steps of:
providing a rail located above a floor;
supporting at least two robot arms on the rail for mutual relative displacement and coordinated displacement along the rail, each arm including a gripper;
using the grippers to engage the workpiece at mutually spaced locations;
using the arms to lift the workpiece while engaged by the grippers;
displacing the robot arms while holding the workpiece by the grippers and articulating the robot arms to change the disposition of the workpiece relative to the rail; and
releasing the workpiece from engagement by the grippers.

8. The method of claim 7, further comprising the steps of:
using a controller to articulate the robot arms such that the grippers engage and support the workpiece on the robot arms; and
using a controller to displace the robot arms while holding the workpiece by the grippers.

9. A method for moving a workpiece within a workspace, comprising the steps of:
spanning the workspace by a rail of a desired length located above the workspace and extending between a first location where the workpiece is received and a second location where the workpiece is delivered;
mounting at least two articulating robot arms on the rail, each arm carrying a gripper;
engaging the grippers on the workpiece at the first location;
carrying the workpiece to the second location; and
releasing the grippers from the workpiece at the second location.

10. The method of claim 9, further comprising the steps of:
using a controller to articulate the robot arms such that the grippers engage the workpiece at the first location and support the workpiece; and
using a controller to displace the robot arms from the first location to the second location while holding the workpiece by the grippers.

11. The method of claim 9, wherein the carrying step further comprises coordinating displacement and articulation of the robot arms while holding the workpiece by the grippers.

12. A gantry robot system for handling and transporting workpieces of variable size, weight and dimensions in a workspace having a floor, comprising:
two rails supported above the floor;
two robot arms, one robot arm supported on each rail for mutual relative displacement and coordinated displacement along the rails, each robot arm supporting a gripper and capable of articulating about multiple axes for engaging and supporting the workpiece by the grippers; and
a controller communicating with each of the robot arms to control displacement and articulation of each robot arm, whereby the workpiece is lifted by the robot arms employing the grippers, carried, and released from the grippers.

13. The system of claim 12, further comprising:
columns spaced mutually along each rail, extending upward from the floor, and secured at a base; and
wherein each rail is located adjacent at least two columns, and includes a first surface secured to the respective columns, and a second vertically disposed surface on which the respective robot arm is supported.

14. The system of claim 12, further comprising:
columns spaced mutually along each rail, extending upward from the floor, and secured at a base; and
wherein each rail is located adjacent at least two columns, and includes a first surface secured to the respective columns, and a second surface on which the robot arms are supported.

15. The system of claim 13, wherein each robot arm includes:
multiple axes disposed along the arm and about which the arm articulates; and
a wrist located at an end of the arm for supporting a gripper thereon.

16. The system of claim 13, wherein each gripper is secured to the respective robot arm for movement therewith, each gripper engaging the workpiece such that movement of the workpiece relative to the gripper is prevented while the gripper is engaged with the workpiece.

17. The system of claim 13, wherein each gripper engages and supports a workpiece due to at least one of electromagnetic, hydraulic, pneumatic, vacuum, and mechanical actuation.

18. A method for moving a workpiece, comprising the steps of:
providing rails located above a floor;
supporting at least two robot arms on the rail for mutual relative displacement and coordinated displacement along the rail, each arm including a gripper;
using the grippers to engage the workpiece at mutually spaced locations;
using the arms to lift the workpiece while engaged by the grippers;
displacing the robot arms while holding the workpiece by the grippers and articulating the robot arms to change the disposition of the workpiece relative to the rail; and
releasing the workpiece from engagement by the grippers.

19. The method of claim 18 further comprising the steps of:
using a controller to articulate the robot arms such that the grippers engage and support the workpiece; and
using a controller to displace the robot arms while holding the workpiece by the grippers.

20. A method for moving a workpiece within a workspace, comprising the steps of:
spanning the workspace by rails of desired respective lengths located above the workspace and extending between a first location where the workpiece is received and a second location where the workpiece is delivered;
mounting an articulating robot arm on each rail, each robot arm carrying a gripper;
engaging the grippers on the workpiece at the first location;
carrying the workpiece to the second location; and
releasing the grippers from the workpiece at the second location.

21. The method of claim 20, further comprising the steps of:
using a controller to articulate the robot arms such that the grippers engage the workpiece at the first location and support the workpiece; and
using a controller to displace the robot arms from the first location to the second location while holding the workpiece by the grippers.

22. The method of claim 20, wherein the carrying step further comprises coordinating displacement and articulation of the robot arms while holding the workpiece by the grippers.
